(19) United States
(12) Patent Application Publication
(10) Pub. No.: US 2008/0163298 A1
(43) Pub. Date: Jul. 3, 2008

(54) DISPLAY APPARATUS AND METHOD FOR CONTROLLING THE SAME

(75) Inventors: Bo-seok MOON, Seoul (KR); Hyung-chan KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/833,782

(22) Filed: Aug. 3, 2007

(30) Foreign Application Priority Data
Dec. 27, 2006 (KR) 2006-135572

(51) Int. Cl. H04N 5/445

(52) U.S. Cl. 725/44

(57) ABSTRACT

A display apparatus connected to a broadcast receiver including a plurality of tuners is provided. The display apparatus includes an interface unit which is connected to at least one device including the broadcast receiver, according to a communication protocol allowing control of an external device; an input unit which inputs a user instruction; and a control unit which controls the display apparatus so that a channel can be selected by selecting one of a plurality of tuners, which is in an available state, if the broadcast receiver is selected from the at least one device connected to the interface unit according to the user instruction. Accordingly, a user can promptly, easily use a desired tuner function.

### CROSS-REFERENCE TO RELATED APPLICATIONS

This application claims priority under 35 U.S.C. §119 from Korean Patent Application No. 10-2006-0135572, filed on Dec. 27, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a method for controlling the display apparatus, and more particularly to a display apparatus displaying a broadcast receiver including a plurality of tuners on a device list in the form of a designation item and a method for controlling the display apparatus.

2. Description of the Related Art

In recent years, a technology for processing a digitized audio/video (A/V) device has been remarkably developed, and various A/V devices such as a digital television (TV), set-top boxes, DVD players, and digital amplifiers have been installed and used at home or in an office. Further, a user at home or in an office can conveniently control such devices using remote controllers. However, the larger the number of A/V devices installed in a space is, the more complicated and difficult the control of the devices becomes.

Accordingly, a technology for connecting and systemizing a plurality of A/V devices and for allowing a user to conveniently control the systemized A/V devices has been researched. The essential point of the research is that one A/V network system can be obtained by connecting A/V devices through a network interface.

Wire communication methods for connecting the devices include a universal serial bus (USB) using a separate communication for transmitting data at a high speed, Ethernet and IEEE 1394, a Home phoneline networking alliance (PNA) using a conventional telephone wire, and a power line communication (PLC) using a power line.

USB is used to connect PC peripheral devices and Ethernet is used to connect a PC, a printer, etc. Further, IEEE 1394 is used to connect an A/V device and a PC peripheral device, and Home PNA is used to connect a PC, a printer, a telephone, etc. Power line communication is used to connect various arrangements for home automation, a sensor, etc.

Further, wireless communication methods for connecting various devices include a home radio frequency (RF) having the band of 2.4 GHz, IEEE 802.11b using a direct sequence spread spectrum (DSSS) method at the band of 2.4 GHz, IEEE 802.11a using the band of 5 GHz, Bluetooth supporting the transmission speed of 1 Mbps, Hyper LAN2 having the band of 5 GHz, ultra wide band (UWB) using a very wide frequency band of more than a few GHz in the base band without using a wireless carrier wave, Zigbee which is a short range, low date rate wireless communication standard, and infrared data association (IrDA).

Home RF connects various home appliances including a PC, and Bluetooth connects an Ad Hoc network, a WPAN, and PC peripheral devices. The wireless LAN includes IEEE 802.11a and IEEE 802.11b for data transmission of A/V devices such as audio and video, and UWB connects A/V devices, home appliances, and PC peripheral devices. Further, Zigbee connects home appliances and various sensors for control of lights and home security system.

Recently, as a part of the research, a technology standard for expandable home theater (XHT), which is middleware for A/V home networking, has been developed and suggested.

The XHT technology is a home network solution around a digital TV, which has been developed by Samsung, and has been adopted as a standard of the consumer electronics association (CEA). The XHT technology controls a plurality of digital TVs as well as A/V devices connected to digital TVs using IEEE 1394 cables capable of stably transferring a plurality of high definition (HD) signals and internet protocols which are communication standards mainly used in the Internet. According to the XHT technology, a digital broadcast can be watched in a bed room by utilizing a digital broadcast receiving function of a digital TV located in a living room.

However, in the case in which a digital TV controls a plurality of tuners provided in a broadcast receiver, since broadcast receiver icons corresponding to the tuners are displayed on a device list called by the digital TV, a user can be confused by the broadcast receiver icons. Further, when the icons corresponding to the tuners and information on use of the tuners are displayed, the sizes of the icons make it difficult to provide sufficient information. Further, in the case of a plurality of tuners, a user having insufficient knowledge of the usage of the broadcast receiver can be confused, because usage of such a system is different from that of a broadcast receiver having one tuner.

### SUMMARY OF THE INVENTION

Exemplary embodiments of the present invention are directed to overcoming the above disadvantages and other disadvantages not described above. The present invention, however, is not required to overcome the disadvantages described above, and certain exemplary embodiments of the present invention may not overcome any of the problems described above.

The present invention provides a display apparatus capable of allowing a user to easily use a tuner function by displaying a broadcast receiver having a plurality of tuners as one designation item on a device list in the case in which at least one tuner is in an available state, and a method for controlling the display apparatus.

According to an aspect of the present invention, there is provided a display apparatus connected to a broadcast receiver including a plurality of tuners, the display apparatus comprising: an interface unit which is connected to at least one device including the broadcast receiver, according to a communication protocol allowing control of an external device; an input unit which inputs a user instruction; and a control unit which controls the display apparatus so that a channel can be selected by selecting one of a plurality of tuners, which is in available state, if the broadcast receiver is selected from the at least one device connected to the interface unit according to the user instruction.

The display apparatus may further comprise: an output unit which displays a list on the at least one device connected through the interface unit and the control unit may control the output unit to display the broadcast receiver in the form of one designation item on the list, if at least one of the plurality of tuners provided in the broadcast receiver is in an available state.

The control unit may control the display apparatus so that a channel can be selected by arbitrarily selecting one of the plurality of tuners when at least two of the plurality of tuners are in available states.

The display apparatus may further comprise: a control unit which displays a list on the at least one device connected through the interface unit and the control unit may control the output unit to display a plurality of broadcast receiver designation items corresponding to the plurality of tuners on the list when none of the plurality of tuners is in an available state.

The control unit may control the display apparatus so that a channel can be selected using a tuner corresponding to the selected broadcast receiver designation item if one of the broadcast receiver designation items displayed on the list is selected.

The control unit may control the output unit so that the plurality of broadcast receiver designation items corresponding to the plurality of tuners and information on the usage states of the tuners can be displayed on the list if none of the plurality of tuners is in an available state and may control the display apparatus so that a channel can be selected using a tuner corresponding to the selected broadcast receiver designation item if one of the plurality of broadcast receiver designation items displayed on the list is selected.

The designation item may be displayed in the form of an icon.

The communication protocol is a protocol according to an XHT standard.

According to another aspect of the present invention, there is provided a method for controlling a display apparatus connected to at least one device according to a communication protocol allowing control of an external device, the method comprising: checking the availability states of a plurality of tuners if the at least one device includes a broadcast receiver including the plurality of tuners; and selecting one of the plurality of tuners according to the result of the check, and controlling selection of a channel if the broadcast receiver is selected from the at least one device.

The method may further comprise: displaying a list including a designation item on the at least one device. The selecting may comprise controlling the selecting of a channel using an available one of the plurality of tuners if the designation item of the broadcast receiver is selected on the list.

The displaying the list may comprise expressing the broadcast receiver as one designation item on the list, if at least one of the plurality of tuners is in an available state after the check.

The selecting may comprise automatically selecting an arbitrary tuner to control the selection of a channel, if at least two of the plurality of tuners are in an available state.

The displaying the list may comprise displaying a plurality of broadcast receiver designation items corresponding to the plurality of tuners on the list, if none of the plurality of tuners is in an available state.

The selecting may comprise controlling the selection of a channel using a tuner corresponding to the selected broadcast receiver designation item, if one of the plurality of broadcast receiver designation items displayed on the list is selected.

The designation item may be displayed in the form of an icon.

The communication protocol may be a protocol according to an XHT standard.

### BRIEF DESCRIPTION OF THE DRAWINGS

The above and/or other aspects of the present invention will be made more apparent by a description of certain exemplary embodiments of the present invention with reference to the accompanying drawings, in which:

FIG. 1 is a block diagram showing a display apparatus according to an exemplary embodiment of the present invention;

FIG. 2 is a block diagram showing a system including a device connected to the display apparatus of FIG. 1 according to an exemplary embodiment of the present invention;

FIG. 3 is a block diagram showing a display apparatus according to another exemplary embodiment of the present invention;

FIGS. 4A and 4B are views showing external device lists displayed on a screen of the display apparatus of FIG. 3 according to an exemplary embodiment of the present invention;

FIG. 5 is a flow chart explaining a method for controlling a display apparatus according to an exemplary embodiment of the present invention; and

FIG. 6 is a flow chart explaining a method for controlling a display apparatus of FIG. 5 in detail, according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

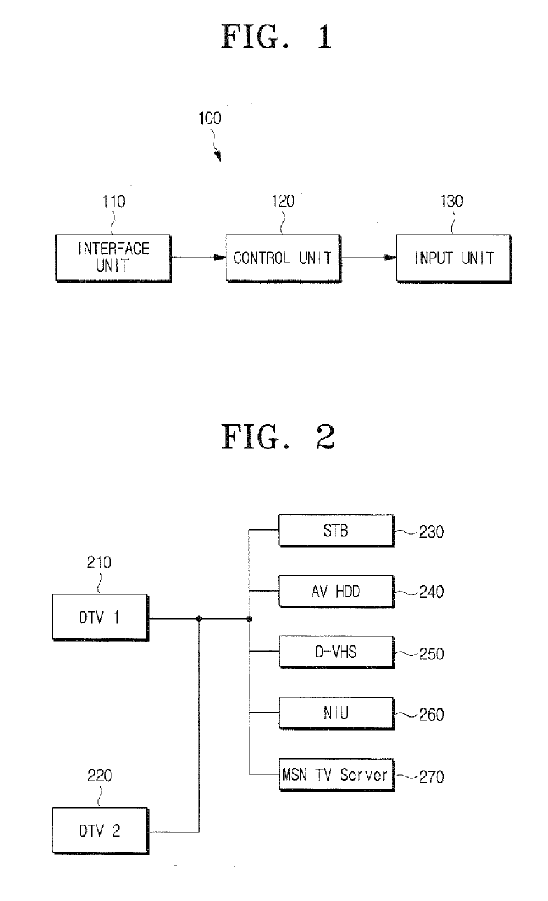

FIG. 1 is a block diagram showing a display apparatus according to an exemplary embodiment of the present invention. As shown in FIG. 1, the display apparatus 100 includes an interface unit 110, a control unit 120, and an input unit 130. The display apparatus 100 can be realized by a digital TV or can be realized by a PDP, an LCD monitor, an audio receiver, etc. Further, the display apparatus can be connected to an external device using a communication protocol according to the XHT standard.

The XHT communication method is a technology capable of controlling a plurality of digital TVs as well as a video and audio device connected to a digital TV using an IEEE 1394 cable capable of stably transmitting a plurality of high definition (HD) signals, and an IP over 1394 protocol using internet protocol (IP) which is a communication standard mainly used in the Internet.

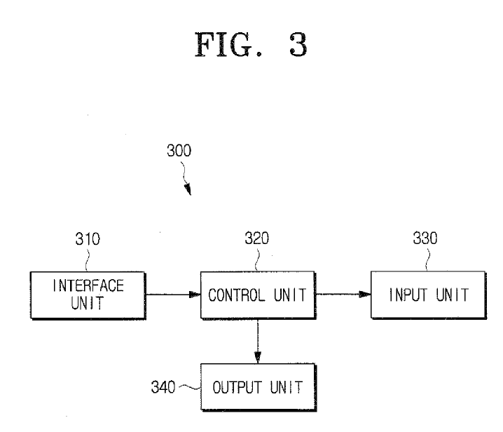

FIG. 2 shows a system connecting a plurality of devices including the display device shown in FIG. 1 according to the XHT communication method. Here, the display apparatus 100 shown in FIG. 1 can be realized by a DTV 1 210 and a DTV 2 220.

Referring to FIG. 2, devices including a DTV 1 210, a DTV 2 220, a set-top box (STB) 230, an audio/video hard disc drive (AV HDD) 240, a digital-video home system (D-VHS) 250, and a network interface unit (NIU) 260 are connected to each other through the IEEE 1394 cable. Here, the D-VHS 250 refers to a high capacity record video for DTV record and the NIU 260 is a low-priced network interface unit which has been developed on the basis of the XHT technology. The NIU 260 takes the form of a memory card and can be easily changed according to reception methods using terrestrial waves, satellite waves, and cables to lessen the burdens of broadcast enterprisers. The NIU 260 is an important element constituting the XHT together with a digital TV and is a digital device allowing a video/audio service of a high quality with minimum cost in correspondence to the activation of the built-in digital TV market.

The IEEE 1394 is a standard of a new series interface standardized by the IEEE. The IEEE 1394 was developed by Apple Computer Inc. in the name of FireWire as a standard which can replace a small computer system interface (SCSI) and was formally employed as a standard in 1995. The IEEE 1394 has been developed as an interface connecting electronic devices such as a video camera, an audio product, a TV, a video cassette recorder (VCR), and a computer peripheral device, to a personal computer (PC), and has three data transmission speeds of 100 MB/s, 200 MB/s, and 400 MB/s.

The data transmission includes two types including an isochronous transmission and an asynchronous transmission. Since the isochronous transmission is a real time transmission, it is suitable for an interface transmitting multimedia information requiring synchronism of an image and a sound. Further, since the asynchronous transmission is a method dividing data to transmit the data, it can be used in transferring the data between peripheral devices such as a PC and a hard disc.

By using the XHT communication method, even in the case in which a digital broadcast receiver is provided only in a DTV in a living room and the receiver is not provided in a DTV in a bed room, a digital broadcast can be watched even in the bed room by utilizing the digital broadcast receiving function of the DTV in the living room. Further, it is similar even in the case in which a DVD player, a home theater, a camcorder, etc. are connected only to the DTV in the living room. Therefore, various contents such as movies, music, games, and educational content, can be used by connecting the DTV to the Internet and simply manipulating a remote controller.

The interface unit 110 is connected to at least one device according to a communication protocol allowing control of an external device, and especially to a broadcast receiver including a plurality of tuners. Here, the external device may be an A/V device, and more specifically, may be a personal video recorder (PVR), a digital video disc recorder (DVDR), a data-video home system (D-VHS), a set-top box (STB), and an audio video disk drive (AV HDD). More particularly, the interface unit 110 can be realized by an IEEE 1394 terminal and performs communication between the display apparatus 100 and an external device (not shown) connected thereto. That is, the interface unit 110 can transmit various data to an external device, under the control of a control unit 120 which will be described later, and can receive the data transmitted from the external device and transfers the data to the control unit 120.

Hereinafter, the operation order of the A/V devices realized by the XHT communication method will be described. First, local IP addresses are automatically allocated to the A/V devices in an XHT network by a predetermined address allocating algorithm. Next, the A/V devices to which the local IP addresses are allocated express device information of their own in an extensible markup language (XML) file (DeviceInfo.xml) according to a construction format (defined by a DeviceInfo.xsd) and transmits it to other A/V devices. A uniform resource identifier (URI) of a file (XHT931.xsd) describing sets of hypertext transfer protocol (HTTP) for operating the A/V devices is recorded in the DeviceInfo.xml. The A/V device which has produced the DeviceInfo.xml produces an XML file (XHT931.xml) in which the HTTP instructions supporting the corresponding device are recorded with reference to XHT931.xsd and transmits it to other A/V devices. With respect to one A/V device, another A/V device which has received the DeviceInfo.xml expressing the device information and the XHT931.xml recording the supporting HTTP instructions can recognize the information on the A/V device which has transmitted the files using the received files and can control the A/V device using the HTTP instructions.

Since the devices following the XHT standard have device controllers converting the HTTP instructions to device operations, they can perform the operations corresponding to the transferred instructions. Therefore, the device following the XHT standard can transmit a TS to a digital TV using the IEEE 1394 network and the digital TV which has received the TS can decode it and can display it to a user.

Hereinafter, other embodiments of a display apparatus and a method for controlling the apparatus according to the present invention, which follow a communication protocol according to the XHT standard, will be described in detail.

A control unit 120 controls the overall operation of the elements of the display apparatus 100 and can also control another display connected through the IEEE 1394 protocol. Further, the control unit can control the operation of an A/V device connected to the display apparatus, such as a D-VHS 250 and an AV HDD 240.

An input unit 130 is provided to input a user instruction and can be realized by a remote controller including a plurality of keys and a key panel included in the display apparatus 100 itself The input unit 130 is provided to input a user instruction for controlling the operation of an external device connected to the display apparatus 100 as well as a user instruction for controlling the operation of the display apparatus 100 itself.

Further, if a broadcast receiver (not shown) is selected from at least one device connected to an interface unit 120 according to the user instruction input through the input unit 130, the control unit 120 controls the display apparatus 100 to select one of a plurality of tuners included in the broadcast receiver (not shown), which is in an available state, and select a channel.

Further, if the broadcast receiver is selected from the at least one device connected to the interface unit 110, the control unit 120 determines one or more of the plurality of tuners included in the broadcast receiver, which are in an available state.

In making the determination, if at least two tuners are in an available state, one of the tuners which are in an available state is controlled to be arbitrarily selected to select a channel. Further, if only one of the plurality of tuners is in an available state, the corresponding tuner is controlled to be selected to select a channel.

Here, the available state of the tuner refers to the case in which the corresponding tuner is not being used by any device and can be checked by the display apparatus 100 according to the communication method of the XHT standard.

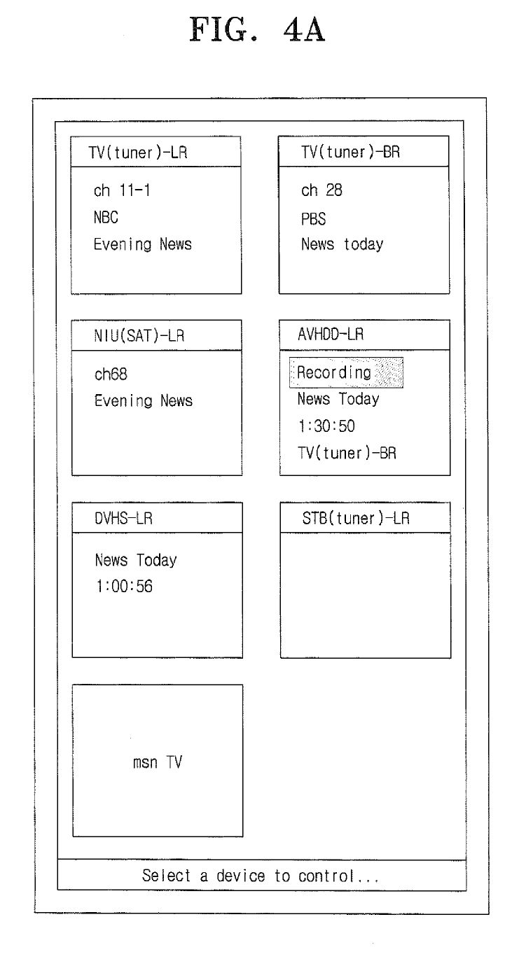

FIG. 3 is a block diagram showing a display apparatus according to another exemplary embodiment of the present invention. As shown in FIG. 3, the display apparatus 300 includes an interface unit 310, a control unit 320, an input unit 330, and an output unit 340. Parts of FIG. 3, which are the same as in the exemplary embodiment of FIG. 1, will not be repeated.

The output unit 340 displays a list on at least one device through the interface unit 310. The output unit 340 can display the device list in the form of an icon or text, and can be realized in various forms in some cases.

If at least one of the plurality of tuners provided in a broadcast receiver is in an available state, the control unit 320 can control the output unit 340 so that the broadcast receiver can be displayed in the form of one designation item on the list on a device displayed by the output unit 340.

In this case, if the broadcast receiver designation item is selected according to a user instruction input through the input unit 330, the control unit 320 controls the display apparatus 300 to select an arbitrary one of the plurality of tuners, which is in an available state, and select a channel.

Further, if none of the plurality of tuners is in an available state, the control unit 320 can control the output unit 340 to display the plurality of broadcast receiver designation items corresponding to the plurality of tuners on the list on the at least one device displayed on the output unit 340.

In this case, if one of the broadcast receiver designation items displayed on the list is selected according to a user instruction input through the input unit 330, the control unit 320 controls the display apparatus 300 to select a channel using the tuner corresponding to the selected broadcast receiver designation item.

Further, if none of the plurality of tuners is in an available state, the control unit 320 can control the output unit 340 to display the plurality of broadcast receiver designation items corresponding to the plurality of tuners, and the information on the usage states of the tuners on the list, on at least one device.

In this case, if one of the plurality of broadcast receiver designation items displayed on the list is selected according to the user instruction input through the input unit 330, the control unit 320 can control the display apparatus 300 to select a channel using the tuner corresponding to the selected broadcast receiver designation item.

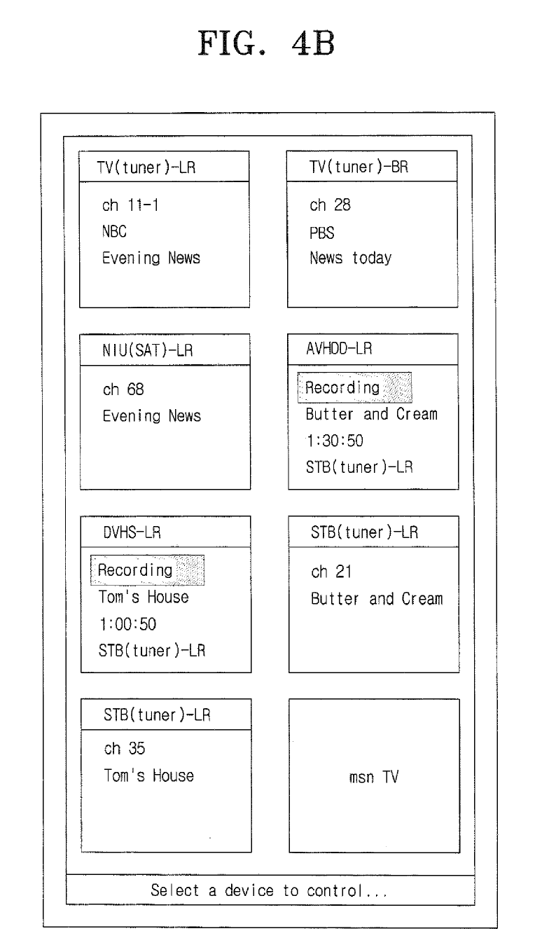

FIGS. 4A and 4B show device lists displayed on a screen of the display apparatus 300 shown in FIG. 3.

FIG. 4A shows a device list displayed on a screen in the case in which at least one of a plurality of tuners provided in a broadcast receiver connected to the display apparatus 300 of FIG. 3 is in an available state.

Referring to FIG. 4A, designation items of a digital TV TV-LR located in a living room, a digital TV TV-BR located in a bed room, an NIU connected to the digital TV in the living room, an AV HDD, a D-VHS, etc., and information on used states of the devices, are displayed. Here, one designation item is displayed representing an STB in the case in which one of a plurality of tuners provided in the STB, which is a broadcast receiver, is in an available state. In this case, it can be seen that at least one of the plurality of tuners provided in the STB is in an available state. If a user selects the STB designation item in the case in which at least two tuners are in available state, the display apparatus 300 can arbitrarily select one of the plurality of tuners which is in an available state, and can select a channel.

FIG. 4B shows a device list displayed on a screen in the case in which none of a plurality of tuners provided in a broadcast receiver connected to the display apparatus 300 of FIG. 3 is in an available state.

Referring to FIG. 4B, designation items of a digital TV LR-TV located in a living room, a digital TV BR-TV located in a bed room, an NIU connected to the digital TV located in the living room, an AV HDD, a D-VHS, etc., and information on usage states of the devices, are displayed. In FIG. 4B, the case is exemplified in which tuners provided in an STB which is a broadcast receiver are dual tuners. Here, neither of two tuners provided in the STB is in an available state, and the designation items representing the STB are displayed on the device list in correspondence to the tuners. In this case, a user can confirm use information of a plurality of tuners provided in the STB and can select and use a desired tuner. In the present embodiment, dual tuners are exemplified. However, the same method can be applied to the case of more than two tuners.

In FIGS. 4A and 4B, items indicating the devices are explained as designation items, but they can be realized in various forms such as icons or texts.

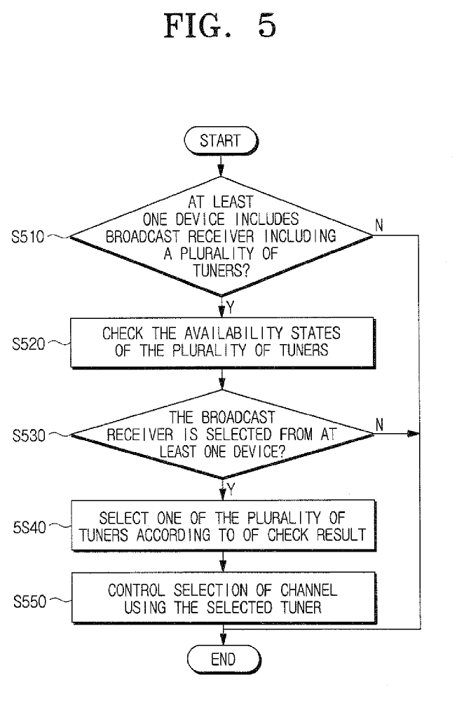

FIG. 5 is a flow chart for explaining a method for controlling a display apparatus according to an exemplary embodiment of the present invention. According to the method shown in FIG. 5, if a user inputs a user instruction for selecting a device connected to the display device, the method confirms whether at least one device connected to the display apparatus includes a broadcast receiver including a plurality of tuners (S510). Here, the communication protocol may be a protocol according to the XHT standard.

In the confirmation in S510, if the at least one device includes a broadcast receiver including a plurality of tuners (S510:Y), the available states of the plurality of tuners are checked (S520). Then, the method confirms whether the broadcast receiver is selected from the at least one device connected to the display apparatus (S530).

In the confirmation in S530, if the broadcast receiver is selected from the at least one device (S530:Y), one of the plurality of tuners is selected according to the result of the check (S540). The selection of a channel is controlled using the tuner selected in S540 (S550).

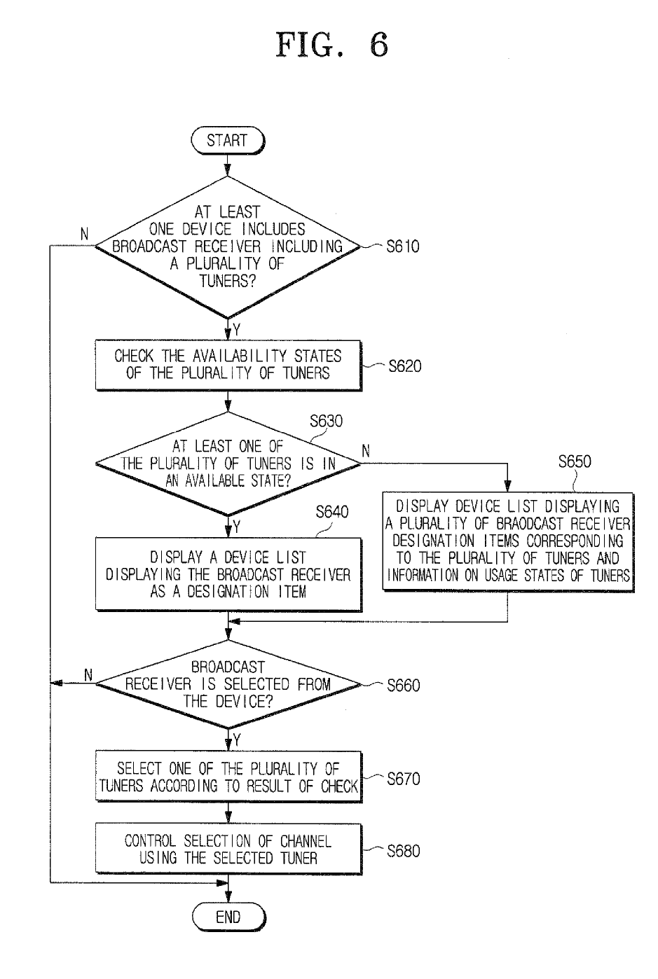

FIG. 6 is a flow chart for explaining the method for controlling the display apparatus of FIG. 5 in detail. According to the method for controlling the display apparatus of FIG. 6, if a user inputs a user instruction for selecting a device connected to the display apparatus, the method confirms whether at least one device includes a broadcast receiver including a plurality of tuners (S610).

In the confirmation in S610, if the at least one device includes the broadcast receiver including a plurality of tuners(S610:Y), the availability states of the plurality of tuners are checked (S620). Thereafter, the method determines whether at least one of the plurality of tuners is in an available state (S630).

In the determination in S630, if at least one of the plurality of tuners is determined to be in an available state (S630:Y), a device list representing the broadcast receiver as one designation item is displayed (S640).

In the determination in S630, if one of the plurality of tuners are in an available state (S630:N), a device list representing a plurality of broadcast receiver designation items corresponding to the plurality of tuners, and information on the use states of the tuners, is displayed (S650). Here, the designation items can be displayed in the form of icons and can be changed to various forms such as text. Then, the method confirms whether the broadcast is selected from the at least one device (S660).

In the confirmation in S660, if the broadcast receiver is selected from the at least one device (S660:Y), one of the plurality of tuners is selected according to the result of the check (S670). Thereafter, the selection of a channel is controlled using the tuner selected in S670 (S680).

Accordingly, a user can easily use functions of the broadcast receiver including the plurality of tuners.

As mentioned above, according to the present invention, the operation of a broadcast receiver including a plurality of tuners can be automated and a user selection screen for this can be minimized. Accordingly, even a user having insufficient knowledge on a broadcast receiver including a plurality of tuners can easily use the broadcast receiver, thereby remarkably improving its convenience to a user.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims; many alternatives, modifications, and variations will be apparent to those skilled in the art.

What is claimed is:

1. A display apparatus connected to a broadcast receiver including a plurality of tuners, the display apparatus comprising:
an interface unit which is connected to at least one device including the broadcast receiver, according to a communication protocol for a control of the at least one device;
an input unit which inputs a user instruction; and
a control unit which controls the display apparatus according to the user instruction, so that a channel is selected by selecting one of the plurality of tuners which is in an available state, if the broadcast receiver is selected from the at least one device connected to the interface unit.

2. The display apparatus as claimed in claim 1, further comprising:
an output unit which displays a list on the at least one device connected through the interface unit,
wherein the control unit controls the output unit to display the broadcast receiver in a form of one designation item on the list, if at least one of the plurality of tuners provided in the broadcast receiver is in an available state.

3. The display apparatus as claimed in claim 1, wherein the control unit controls the display apparatus so that a channel is selected by arbitrarily selecting one of the plurality of tuners when at least two of the plurality of tuners are in available states.

4. The display apparatus as claimed in claim 1, further comprising:
a control unit which displays a list on the at least one device connected through the interface unit,
wherein the control unit controls the output unit to display a plurality of broadcast receiver designation items corresponding to the plurality of tuners on the list when none of the plurality of tuners is in an available state.

5. The display apparatus as claimed in claim 4, wherein the control unit controls the display apparatus so that a channel is selected using a tuner corresponding to the selected broadcast receiver designation item if one of the broadcast receiver designation items displayed on the list is selected.

6. The display apparatus as claimed in claim 4, wherein:
the control unit controls the output unit so that the plurality of broadcast receiver designation items corresponding to the plurality of tuners, and information on the usage states of the tuners, is displayed on the list if none of the plurality of tuners is in an available state; and
the control unit controls the display apparatus so that a channel can be selected using a tuner corresponding to the selected broadcast receiver designation item if one of the plurality of broadcast receiver designation items displayed on the list is selected.

7. The display apparatus as claimed in claim 2, wherein the designation item is displayed in a form of an icon.

8. The display apparatus as claimed in claim 1, wherein the communication protocol is a protocol according to an XHT standard.

9. A method for controlling a display apparatus connected to at least one device according to a communication protocol for a control of the at least one device, the method comprising:
checking availability states of a plurality of tuners if the at least one device includes a broadcast receiver including the plurality of tuners; and
selecting one of the plurality of tuners according to the result of the check, and controlling selection of a channel if the broadcast receiver is selected from the at least one device.

10. The method as claimed in claim 9, further comprising:
displaying a list including a designation item on the at least one device;
wherein the selecting comprises controlling the selection of a channel using an available one of the plurality of tuners, if the designation item of the broadcast receiver is selected on the list.

11. The method as claimed in claim 10, wherein the displaying the list comprises expressing the broadcast receiver as one designation item on the list, if at least one of the plurality of tuners is in an available state after the check.

12. The method as claimed in claim 10, wherein the selecting comprises automatically selecting an arbitrary tuner to control the selection of a channel, if at least two of the plurality of tuners are in an available state.

13. The method as claimed in claim 10, wherein the displaying the list comprises displaying a plurality of broadcast receiver designation items corresponding to the plurality of tuners on the list, if none of the plurality of tuners is in an available state.

14. The method as claimed in claim 13, wherein the selecting comprises controlling the selection of a channel using a tuner corresponding to the selected broadcast receiver designation item, if one of the plurality of broadcast receiver designation items displayed on the list is selected.

15. The method as claimed in claim 10, wherein the displaying the list comprises displaying a list representing the plurality of broadcast receiver designation items corresponding to the plurality of tuners and information on the usage states of the tuners, if none of the plurality of tuners is in an available state.

16. The method as claimed in claim 10, wherein the designation item is displayed in the form of an icon.

17. The method as claimed in claim 9, wherein the communication protocol is a protocol according to an XHT standard.
